(19) United States
(12) Patent Application Publication
(10) Pub. No.: US 2024/0158662 A1
(43) Pub. Date: May 16, 2024

(54) TWO-COMPONENT CURABLE COATING AGENT AND MULTILAYER FILM

(71) Applicant: HARIMA CHEMICALS, INC., Hyogo (JP)

(72) Inventors: Masao KIGUCHI, Hyogo (JP); Tetsuya HARADA, Hyogo (JP); Michio OGIHARA, Hyogo (JP)

(73) Assignee: HARIMA CHEMICALS, INC., Hyogo (JP)

(21) Appl. No.: 18/280,755

(22) PCT Filed: Mar. 7, 2022
(86) PCT No.: PCT/JP2022/009783

§ 371 Date: Sep. 7, 2023

(30) Foreign Application Priority Data
Mar. 8, 2021 (JP) 2021-035996

(51) Int. Cl. C09D 175/08; B05D 7/00; C09J 7/35; C09J 201/00

(52) U.S. Cl. CPC C09D 175/08; B05D 7/546; C09J 7/35; C09J 201/00

(57) ABSTRACT

A two-component curable coating agent capable of forming a surface protective layer having excellent weather resistance, acid resistance, fouling resistance, and elongation properties, and a multilayer film including a surface protective layer that is a cured film of the two-component curable coating agent. The two-component curable coating agent includes a main agent that contains a polyol containing an epoxy polyol (P) and an acrylic polyol (A), and a curing agent that contains a polyisocyanate, the epoxy polyol (P) being a reaction product of an epoxy group-containing compound (e) and a carboxyl group-containing compound (c). Furthermore, the multilayer film includes a substrate layer; a surface protective layer that is layered on and integrated with a first surface of the substrate layer and that is a cured film of the two-component curable coating agent; and an adhesive layer that is layered on and integrated with a second surface of the substrate layer.

### TECHNICAL FIELD

The present invention relates to a two-component curable coating agent capable of forming a surface protective layer having excellent weather resistance, acid resistance, fouling resistance, and elongation properties, and also relates to a multilayer film that includes such a surface protective layer, this layer being a cured film of the two-component curable coating agent.

### BACKGROUND ART

Conventionally, articles such as automotives, vehicles, aircrafts, glasses, architectures, and signage have been subjected to surface treatment to protect their surfaces from fouling and damage, thus maintaining their appearance. Such surface treatment is achieved by providing a surface protective layer to the surfaces of the articles. Examples of a surface treatment method include (1) a method in which a coating agent is applied to a surface of an article to form a surface protective layer, and (2) a method in which a multilayer film including a surface protective layer and an adhesive layer is bonded to a surface of an article.

The surface protective layer is formed by curing a coating agent containing a polyol and a polyisocyanate. For example, PTL 1 discloses a high-solid content coating composition containing (A) a hydroxyl group-containing compound having a weight-average molecular weight of 1,000 or less and a hydroxyl value of 200 to 800 and (B) a polyisocyanate compound. PTL 1 further discloses that the component (A) is a reaction product of a carboxyl group-containing compound with an epoxy group-containing compound.

### CITATION LIST

### Patent Literature

PTL 1: Japanese Patent Application Laid-Open No. 2002-138247

### SUMMARY OF INVENTION

### Technical Problem

Surface-treated articles are often used outdoors. Surface-treated articles may be exposed to wind, rain, or a high humidity environment, and may be irradiated with light including ultraviolet light over a long period of time. In such a case, an uneven portion or a discolored portion may be generated on a surface protective layer. Specifically, an uneven portion is first partially generated on a surface of the surface protective layer, gradually made wider on the surface of the surface protective layer with time, and simultaneously a discolored portion, such as a yellow or white-colored portion, is generated in the surface protective layer. Finally, the uneven portion could be spread over the entire surface of the surface protective layer, and simultaneously, the surface protective layer could be entirely discolored into yellow or white. The generation of the uneven portion and the discoloration on the surface protective layer are considered to be due to degradation of components contained in the surface protective layer by light, fixation of solutes contained in rain, air moisture, or the like to the surface of the surface protective layer, and the like. The generation of the uneven portion and the discolored portion on the surface protective layer causes defects in the appearance of the surface protective layer. Therefore, the surface protective layer is required to have excellent weather resistance.

Exposure of the surface of the surface-treated article to acid rain during rainfall may whiten the surface protective layer, resulting in an appearance defect. Therefore, the surface protective layer is also required to have excellent acid resistance.

Attachment of oil residues, such as those caused by fingerprints, to the surface protective layer may also cause appearance defects. Therefore, the surface protective layer is also required to have excellent fouling resistance so that the oil residues attached to the surface protective layer can be easily wiped off.

When the surface protective layer is bonded to the surface of the article or the surface-treated article is molded, a tensile force may be applied to the surface protective layer. However, when the elongation properties of the surface protective layer are low, the surface protective layer cannot withstand the tensile force, and cracking or cleavage may possibly occur. Therefore, the surface protective layer is also required to have excellent elongation properties.

Although PTL 1 discloses the solid content coating composition as described above, a surface protective layer formed from the solid content coating composition has a problem in that weather resistance, and the like are low.

Therefore, an object of the present invention is to provide a two-component curable coating agent capable of forming a surface protective layer having excellent weather resistance, acid resistance, fouling resistance, and elongation properties, and to provide a multilayer film that includes a surface protective layer, this layer being a cured film of the two-component curable coating agent.

### Solution to Problem

<Two-Component Curable Coating Agent>

The two-component curable coating agent of the present invention includes a main agent that contains a polyol containing an epoxy polyol (P) and an acrylic polyol (A), and a curing agent that contains a polyisocyanate, the epoxy polyol (P) being a reaction product of an epoxy group-containing compound (e) and a carboxyl group-containing compound (c).

In the two-component curable coating agent of the present invention, the polyol contained in the main agent is reacted with the polyisocyanate contained in the curing agent, to form a polyurethane. Thus, the two-component curable coating agent can be cured to form a surface protective layer. Since the polyol in the main agent contains the acrylic polyol (A), the two-component curable coating agent of the present invention can form a surface protective layer having excellent acid resistance and weather resistance. The polyol in the main agent further contains the epoxy polyol (P) that is a reaction product of the epoxy group-containing compound (e) and the carboxyl group-containing compound (c), thereby allowing for the formation of a surface protective layer having excellent fouling resistance and elongation properties.

Since the polyol of the main agent contains the acrylic polyol (A) in combination with the epoxy polyol (P), the two-component curable coating agent of the present invention allows for the formation of a surface protective layer having excellent weather resistance, acid resistance, fouling resistance, and elongation properties.

[Main Agent]

The two-component curable coating agent of the present invention includes a main agent containing a polyol. The polyol contained in the main agent contains the epoxy polyol (P) and the acrylic polyol (A).

[Epoxy Polyol (P)]

The epoxy polyol (P) contained in the main agent is a reaction product of an epoxy group-containing compound (e) and a carboxyl group-containing compound (c).

(Epoxy Group-Containing Compound (e))

The epoxy group-containing compound (e) for use in the formation of the epoxy polyol (P) is preferably a compound having two or more epoxy groups within one molecule. The epoxy group-containing compound (e) preferably has five or less epoxy groups within one molecule. The epoxy group-containing compound (e) particularly preferably has two epoxy groups within one molecule.

Preferable examples of the epoxy group-containing compound (e) include a reaction product of a hydroxyl group-containing compound and an epihalohydrin. A ring-opened adduct, which is formed by an epihalohydrin subjected to a ring-opening addition reaction to a hydroxyl group of a hydroxyl group-containing compound, is ring-closed by an elimination reaction of a hydrogen atom and a halogen atom, to form an epoxy group. As a result, the epoxy group-containing compound (e) can be obtained. An epihalohydrin is preferably reacted with each of at least two hydroxyl groups of a hydroxyl group-containing compound to obtain the epoxy group-containing compound (e) having at least two epoxy groups.

Hydroxyl Group-Containing Compound

The hydroxyl group-containing compound for use in the formation of the epoxy group-containing compound (e) is preferably a compound having two or more hydroxyl groups (—OH) within one molecule. The hydroxyl group-containing compound preferably has six or less hydroxyl groups within one molecule. The hydroxyl group-containing compound particularly preferably has two hydroxyl groups within one molecule.

Examples of the hydroxyl group-containing compound include an aromatic polyphenol such as phenol, bisphenol A, bisphenol F, bisphenol AD, and bisphenol S; a polyhydric alcohol having an alicyclic structure such as hydrogenated bisphenol A, hydrogenated bisphenol F, hydrogenated bisphenol AD, hydrogenated bisphenol S, and 1,4-cyclohexanedimethanol; and an acyclic aliphatic polyhydric alcohol such as ethylene glycol, propylene glycol, hexanediol, diethylene glycol, neopentyl glycol, glycerin, trimethylolpropane, pentaerythritol, and dipentaerythritol. The hydroxyl group-containing compound may be used alone or two or more types thereof may be used in combination.

The hydroxyl group-containing compound is preferably a polyhydric alcohol having an alicyclic structure. Due to the polyhydric alcohol having an alicyclic structure, the alicyclic structure can be introduced into the epoxy group-containing compound (e). Thus, a surface protective layer having excellent weather resistance, acid resistance, fouling resistance, and elongation properties can be formed.

In the present invention, the term “alicyclic structure” refers to a structure in which carbon atoms are bonded to form a ring and which does not have aromaticity. In addition, the term “aromaticity” means a ring system having (4n+2) π-electrons (n is a natural number) according to Huckel's rule.

Examples of the alicyclic structure in the polyhydric alcohol having an alicyclic structure include a cycloalkane structure such as a cyclopropane structure, cyclobutane structure, a cyclopentane structure, a cyclohexane structure, a cyclooctane structure, and a cyclodecane structure. Among these, a cyclohexane structure is preferable. The hydroxyl group-containing compound may contain one type of alicyclic structure or two or more types of alicyclic structures.

As the polyhydric alcohol having an alicyclic structure in the hydroxyl group-containing compound, hydrogenated bisphenol A and hydrogenated bisphenol F are preferable, and hydrogenated bisphenol A is more preferable.

Epihalohydrin

Specific examples of the epihalohydrin used in the formation of the epoxy group-containing compound (e) include epichlorohydrin, epibromohydrin, epifluorohydrin, epiiodohydrin, methyl epichlorohydrin, and methyl epibromohydrin. Among these, epichlorohydrin is preferable. The epihalohydrin may be used alone, or two or more types thereof may be used in combination.

As a method for producing the epoxy group-containing compound (e), a publicly known method, in which a hydroxyl group-containing compound is converted to a glycidyl ether using the epihalohydrin, can be used. Examples thereof include a method including a first step of reacting the hydroxyl group-containing compound with the epihalohydrin to obtain a ring-opened adduct in which the epihalohydrin is subjected to a ring-opening addition reaction to the hydroxyl group of the hydroxyl group-containing compound, and a second step of ring-closing the ring-opened adduct by an elimination reaction of a hydrogen atom and a halogen atom in the presence of a basic compound, to form an epoxy group, as a result, obtaining the epoxy group-containing compound (e).

Examples of the basic compound used in the second step include potassium hydroxide, sodium hydroxide, barium hydroxide, magnesium hydroxide, sodium carbonate, and potassium carbonate. Among these, sodium hydroxide is preferable. The basic compound may be used alone, or two or more types thereof may be used in combination.

Specific examples of the epoxy group-containing compound (e) include a diglycidyl ether of an aromatic polyphenol such as a bisphenol A diglycidyl ether and a bisphenol F diglycidyl ether; a diglycidyl ether of a polyhydric alcohol having an alicyclic structure such as a hydrogenated bisphenol A diglycidyl ether, a hydrogenated bisphenol F diglycidyl ether, and a 1,4-cyclohexanedimethanol diglycidyl ether; and a diglycidyl ether of an acyclic aliphatic polyhydric alcohol such as an ethylene glycol diglycidyl ether, a propylene glycol diglycidyl ether, a neopentyl glycol diglycidyl ether, a butanediol diglycidyl ether, and a hexanediol diglycidyl ether. The epoxy group-containing compound (e) may be used alone or two or more types thereof may be used in combination.

The epoxy group-containing compound (e) preferably contains an alicyclic structure. The epoxy group-containing compound (e) having an alicyclic structure allows for the formation of a surface protective layer having excellent weather resistance, acid resistance, fouling resistance, and elongation properties.

Examples of the alicyclic structure in the epoxy group-containing compound (e) include a cycloalkane structure such as a cyclopropane structure, a cyclobutane structure, a cyclopentane structure, a cyclohexane structure, a cyclooctane structure, and a cyclodecane structure. Among these, a cyclohexane structure is preferable. The epoxy group-containing compound (e) may contain one type of alicyclic structure or two or more types of alicyclic structures.

The epoxy group-containing compound (e) having an alicyclic structure can be obtained, for example, by reacting a polyhydric alcohol having an alicyclic structure with an epihalohydrin. As the epoxy group-containing compound (e) having an alicyclic structure, a diglycidyl ether of a polyhydric alcohol having an alicyclic structure is preferable, a hydrogenated bisphenol A diglycidyl ether and a hydrogenated bisphenol F diglycidyl ether are more preferable, and a hydrogenated bisphenol A diglycidyl ether is more preferable.

The epoxy group-containing compound (e) is not limited to the reaction product of the above-described hydroxyl group-containing compound and an epihalohydrin. Examples of the epoxy group-containing compound (e) include an epoxy group-containing compound in which a carbon-carbon double bond of a compound having the carbon-carbon double bond is epoxidized by an oxidizing agent such as hydrogen peroxide. Examples of the compound having a carbon-carbon double bond include cyclohexene, cyclooctene, a bisphenol A diallyl ether, a hydrogenated bisphenol A diallyl ether, a 1,5-pentanediol diallyl ether, and a 1,6-hexanediol diallyl ether.

(Carboxyl Group-Containing Compound (c))

The epoxy polyol (P) contained in the main agent is obtained by reacting the above-described epoxy group-containing compound (e) with the carboxyl group-containing compound (c). As shown in the following formula (I), the epoxy group of the epoxy group-containing compound (e) is subjected to a ring-opening addition reaction to the carboxyl group of the carboxyl group-containing compound (c) to form a hydroxyl group together with an ester bond, thereby obtaining the epoxy polyol (P) having a hydroxyl group.

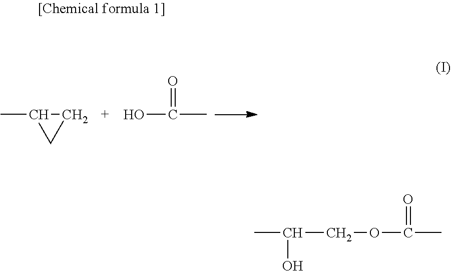

The carboxyl group-containing compound (c) is a compound having one or more carboxyl groups (—COOH) within one molecule.

Specific examples of the carboxyl group-containing compound (c) include a monocarboxylic acid such as acetic acid, propionic acid, butyric acid, 2-ethylhexanoic acid, octanoic acid, dodecanoic acid, palmitic acid, stearic acid, oleic acid, pivalic acid, versatic acid, benzoic acid, hydroxycaprylic acid, hydroxylauric acid, hydroxypalmitic acid, hydroxystearic acid, dihydroxystearic acid, glycolic acid, lactic acid, hydroxypivalic acid, dimethylolpropionic acid, dimethylolbutanoic acid, and gluconic acid; and a polycarboxylic acid such as succinic acid, adipic acid, azelaic acid, sebacic acid, dodecanedioic acid, tetrahydrophthalic acid, phthalic acid, butanetricarboxylic acid, butanetetracarboxylic acid, malic acid, citric acid, and tartaric acid. The carboxyl group-containing compound (c) may be used alone or two or more types thereof may be used in combination.

The carboxyl group-containing compound (c) preferably contains a carboxyl group-containing compound (c1) having one carboxyl group within one molecule. The carboxyl group-containing compound (c1) having one carboxyl group within one molecule can enhance the elongation properties of the surface protective layer.

The carboxyl group-containing compound (c1) preferably has a hydroxyl group. That is, the carboxyl group-containing compound (c1) preferably has a hydroxyl group and has one carboxyl group within one molecule. The use of the carboxyl group-containing compound (c1) having a hydroxyl group allows the epoxy polyol (P) to further have a hydroxyl group derived from the carboxyl group-containing compound (c1). Such an epoxy polyol (P) that is reacted with a polyisocyanate can appropriately enhance the crosslinking density of the obtained polyurethane. As a result, a surface protective layer having not only excellent weather resistance, acid resistance, and fouling resistance but also excellent elongation properties can be formed.

The carboxyl group-containing compound (c1) preferably has one or more hydroxyl groups within one molecule. The carboxyl group-containing compound (c1) preferably has six or less hydroxyl groups within one molecule. It is particularly preferable that the carboxyl group-containing compound (c1) have one hydroxyl group within one molecule.

The carboxyl group-containing compound (c1) preferably has 8 or more carbon atoms, and more preferably 10 or more carbon atoms. The carboxyl group-containing compound (c1) having 8 or more carbon atoms can enhance the elongation properties of the surface protective layer.

Examples of the carboxyl group-containing compound (c1) include a monocarboxylic acid such as acetic acid, propionic acid, butyric acid, 2-ethylhexanoic acid, octanoic acid, dodecanoic acid, palmitic acid, stearic acid, oleic acid, pivalic acid, versatic acid, benzoic acid, hydroxycaprylic acid, hydroxylauric acid, hydroxypalmitic acid, hydroxystearic acid, dihydroxystearic acid, glycolic acid, lactic acid, hydroxypivalic acid, dimethylolpropionic acid, dimethylolbutanoic acid, and gluconic acid. Among these, hydroxycaprylic acid, hydroxylauric acid, hydroxypalmitic acid, hydroxystearic acid, and dihydroxystearic acid are preferable, and hydroxystearic acid is more preferable.

The content of the carboxyl group-containing compound (c1) having one carboxyl group within one molecule in the carboxyl group-containing compound (c) is preferably 50% by mass or more, more preferably 70% by mass or more, and particularly preferably 100% by mass. More specifically, the carboxyl group-containing compound (c) is preferably composed only of the carboxyl group-containing compound (c1) having one carboxyl group within one molecule. The carboxyl group-containing compound (c1) having one carboxyl group within one molecule, when its content is equal to or more than 50% by mass, can further enhance the elongation properties of the surface protective layer.

In addition to the carboxyl group-containing compound (c1) having one carboxyl group within one molecule described above, the carboxyl group-containing compound (c) may further include a carboxyl group-containing compound (c2) having two or more carboxyl groups within one molecule. Use of the carboxyl group-containing compound (c1) and the carboxyl group-containing compound (c2) in combination allows for the formation of a surface protective layer having excellent weather resistance, acid resistance, fouling resistance, and elongation properties.

The carboxyl group-containing compound (c2) preferably has two or more carboxyl groups within one molecule. The carboxyl group-containing compound (c2) preferably has four or less carboxyl groups within one molecule. It is particularly preferable that the carboxyl group-containing compound (c2) have two carboxyl groups within one molecule.

The carboxyl group-containing compound (c2) preferably has 4 or more carbon atoms, more preferably 5 or more carbon atoms, and more preferably 6 or more carbon atoms. The carboxyl group-containing compound (c2) having 4 or more carbon atoms can enhance the elongation properties of the surface protective layer.

Examples of the carboxyl group-containing compound (c2) include succinic acid, adipic acid, azelaic acid, sebacic acid, dodecanedioic acid, tetrahydrophthalic acid, phthalic acid, butanetricarboxylic acid, butanetetracarboxylic acid, malic acid, citric acid, and tartaric acid. Among these, succinic acid, adipic acid, azelaic acid, sebacic acid, dodecanedioic acid, tetrahydrophthalic acid, and phthalic acid are preferable, and succinic acid, adipic acid, and azelaic acid are more preferable.

When the carboxyl group-containing compound (c) contains the carboxyl group-containing compound (c1) and the carboxyl group-containing compound (c2), the content of the carboxyl group-containing compound (c1) in the carboxyl group-containing compound (c) is preferably 50% by mass or more, and more preferably 70% by mass or more. When the carboxyl group-containing compound (c) contains the carboxyl group-containing compound (c1) and the carboxyl group-containing compound (c2), the content of the carboxyl group-containing compound (c1) in the carboxyl group-containing compound (c) is preferably 95% by mass or less, and more preferably 90% by mass or less. The carboxyl group-containing compound (c1), when its content is equal to or more than 50% by mass, can enhance the elongation properties of the surface protective layer.

When the carboxyl group-containing compound (c) contains the carboxyl group-containing compound (c1) and the carboxyl group-containing compound (c2), the content of the carboxyl group-containing compound (c2) in the carboxyl group-containing compound (c) is preferably 5% by mass or more, and more preferably 10% by mass or more. When the carboxyl group-containing compound (c) contains the carboxyl group-containing compound (c1) and the carboxyl group-containing compound (c2), the content of the carboxyl group-containing compound (c2) in the carboxyl group-containing compound (c) is preferably 50% by mass or less, and more preferably 30% by mass or less. The carboxyl group-containing compound (c2), when its content is equal to or less than 50% by mass, can enhance the elongation properties of the surface protective layer.

The epoxy polyol (P) is obtained by reacting the epoxy group-containing compound (e) with the carboxyl group-containing compound (c). It is preferable to obtain the epoxy polyol (P) by reacting the carboxyl group of the carboxyl group-containing compound (c) with each of the at least two epoxy groups of the epoxy group-containing compound (e).

In addition, when the carboxyl group-containing compound (c1) having a hydroxyl group and the carboxyl group-containing compound (c2) are used as the carboxyl group-containing compound (c), the epoxy polyol (P) preferably contains an epoxy polyol (Pᵢ). Herein this epoxy polyol (Pᵢ) is obtained by subjecting the epoxy group-containing compound (e) to a ring-opening addition reaction to each of the at least two carboxyl groups of the carboxyl group-containing compound (c2) to obtain an intermediate product having at least two epoxy groups, and then subjecting the carboxyl group-containing compound (c1) to a ring-opening addition reaction to each of at least two epoxy groups of the intermediate product.

Such an epoxy polyol (Pᵢ) has, at its molecular terminal, the hydroxyl group that was included in the carboxyl group-containing compound (c1), and the hydroxyl group that is formed by the ring-opening addition reaction of the carboxyl group of the carboxyl group-containing compound (c1) and the epoxy group of the intermediate product. Allowing the epoxy polyol (P) that contains such an epoxy polyol (Pᵢ) to react with a polyisocyanate can appropriately enhance the crosslinking density of the obtained polyurethane, whereby a surface protective layer having not only excellent weather resistance, acid resistance, and fouling resistance but also excellent elongation properties can be formed.

More preferably, the epoxy polyol (Pᵢ) is an epoxy polyol (Pᵢ) which is a reaction product of:
the epoxy group-containing compound (e) having two epoxy groups within one molecule,
the carboxyl group-containing compound (c2) having two carboxyl groups within one molecule, and
the carboxyl group-containing compound (c1) having one carboxyl group and one or more hydroxyl groups within one molecule. Herein, the reaction product is obtained by subjecting the epoxy group-containing compound (e) to a ring-opening addition reaction to each of the two carboxyl groups of the carboxyl group-containing compound (c2) to obtain an intermediate product having an epoxy group at each molecular terminal, and then subjecting the carboxyl group-containing compound (c1) to a ring-opening addition reaction to each of the epoxy groups at both molecular terminals of the intermediate product.

It is particularly preferable that the epoxy polyol (Pᵢ) has a structure represented by the following general formula (II).

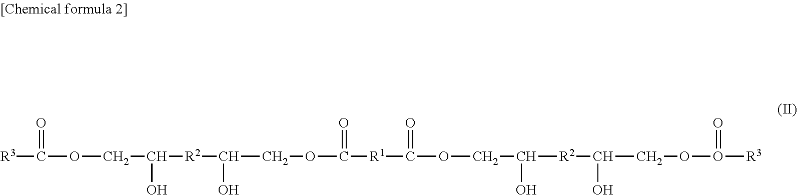

(In the above-described general formula (II),
R¹ represents a residue of a carboxyl group-containing compound (c2) having two carboxyl groups within one molecule but with the two carboxyl groups excluded,
R² represents a residue of the epoxy group-containing compound (e) having two epoxy groups within one molecule but with the two epoxy groups excluded, and
R³ represents a residue of the carboxyl group-containing compound (c1) having one carboxyl group and one or more hydroxyl groups within one molecule but with the carboxyl group excluded.)

The content of the epoxy polyol (Pᵢ) in the epoxy polyol (P) is preferably 20% by mass or more, and more preferably 40% by mass or more. The content of the epoxy polyol (Pᵢ) in the epoxy polyol (P) is preferably 100% by mass or less. The epoxy polyol (Pᵢ), when its content is equal to or more than 20% by mass, allows for the formation of a surface protective layer having not only excellent weather resistance, acid resistance, and fouling resistance but also excellent elongation properties.

When the carboxyl group-containing compound (c1) and the carboxyl group-containing compound (c2) are used as the carboxyl group-containing compound (c), the order in which the epoxy group-containing compound (e), the carboxyl group-containing compound (c1), and the carboxyl group-containing compound (c2) are mixed is not particularly limited. For example, it is preferable to mix the epoxy group-containing compound (e), the carboxyl group-containing compound (c1), and the carboxyl group-containing compound (c2), and then react them. As a result, the epoxy polyol (P) containing the above-described epoxy polyol (Pᵢ) is obtained.

The reaction between the carboxyl group-containing compound (c) and the epoxy group-containing compound (e) may be performed in the presence of a catalyst. Examples of the catalyst include, but are not limited to, an alkali metal hydroxide such as sodium hydroxide and lithium hydroxide, a tertiary amine such as triethylamine, tributylamine, pyridine, and dimethylbenzylamine, imidazoles such as 2-ethyl-4-methylimidazole, a quaternary ammonium salt such as triethylbenzylammonium chloride and tetramethylammonium chloride, a phosphonium salt such as tetrabutylphosphonium chloride and ethyltriphenylphosphonium iodide, and phosphines such as triphenylphosphine. The catalyst may be used alone or two or more types thereof may be used in combination.

In the two-component curable coating agent of the present invention, the content of the epoxy polyol (P) in the polyol of the main agent is preferably 30 parts by mass or more, more preferably 35 parts by mass or more, and more preferably 40 parts by mass or more, relative to 100 parts by mass of the total amount of the epoxy polyol (P) and the acrylic polyol (A). The content of the epoxy polyol (P) in the polyol contained in the main agent is preferably 99 parts by mass or less, more preferably 95 parts by mass or less, more preferably 92 parts by mass or less, more preferably 80 parts by mass or less, and more preferably 65 parts by mass or less, relative to 100 parts by mass of the total amount of the epoxy polyol (P) and the acrylic polyol (A). The epoxy polyol (P), when its content is equal to or more than 30 parts by mass, can enhance the elongation properties of the surface protective layer. The epoxy polyol (P), when its content is equal to or less than 99 parts by mass, can maintain the excellent elongation properties of the surface protective layer, and can also enhance the weather resistance.

[Acrylic Polyol (A)]

The polyol contained in the main agent of the two-component curable coating agent of the present invention contains an acrylic polyol (A) in addition to the epoxy polyol (P) described above. The acrylic polyol (A) is an acrylic polymer that is obtained by polymerizing a (meth)acrylic monomer and that has a hydroxyl group at a terminal or side chain. The acrylic polyol (A) can be obtained by polymerizing a (meth)acrylic monomer using a conventional method for producing an acrylic polymer in the presence of a radical polymerization initiator.

The term “(meth)acrylic” means acrylic or methacrylic. The term “(meth)acrylate” means acrylate or methacrylate.

The acrylic polyol (A) preferably contains a (meth)acrylic monomer (x) component having a glass transition temperature of higher than −10° C. and having an alicyclic structure, and a (meth)acrylic monomer (y) component having a glass transition temperature of −10° C. or lower.

As the acrylic polyol (A), a polymer of a (meth)acrylic monomer including a (meth)acrylic monomer (x) having a glass transition temperature higher than −10° C. and having an alicyclic structure and a (meth)acrylic monomer (y) having a glass transition temperature of −10° C. or lower is preferably mentioned. A copolymer of the (meth)acrylic monomer (x) having a glass transition temperature higher than −10° C. and having an alicyclic structure and the (meth)acrylic monomer (y) having a glass transition temperature of −10° C. or lower is more preferably mentioned.

Note that the “(meth)acrylic monomer (x) having a glass transition temperature higher than −10° C. and having an alicyclic structure” may be simply referred to as a “(meth)acrylic monomer (x)”. Furthermore, the “(meth)acrylic monomer (y) having a glass transition temperature of −10° C. or lower” may be simply referred to as a “(meth)acrylic monomer (y)”.

(Meth)Acrylic Monomer (x)

The glass transition temperature of the (meth)acrylic monomer (x) is preferably higher than −10° C., more preferably 0° C. or higher, and more preferably 15° C. or higher. The glass transition temperature of the (meth)acrylic monomer (x) is preferably 200° C. or lower, more preferably 150° C. or lower, and more preferably 120° C. or lower. The (meth)acrylic monomer (x) having a glass transition temperature higher than −10° C. can enhance the fouling resistance and weather resistance of the surface protective layer.

In the present invention, the “glass transition temperature of the (meth)acrylic monomer” is defined as the glass transition temperature of a homopolymer obtained by homopolymerization of the (meth)acrylic monomer. Furthermore, the glass transition temperature of the homopolymer of the (meth)acrylic monomer is measured by differential scanning calorimetry (DSC) according to JIS K7121 (1987), and the measured value obtained thereby is referred to as a “glass transition temperature of the (meth)acrylic monomer”.

The (meth)acrylic monomer (x) preferably has an alicyclic structure. Examples of the alicyclic structure in the (meta)acrylic monomer (x) include a cycloalkane structure such as a cyclopropane structure, a cyclobutane structure, a cyclopentane structure, a cyclohexane structure, a cyclooctane structure, and a cyclodecane structure, a tetrahydrodicyclopentadiene structure, an adamantane structure, and an isobornyl structure. Among these, a cycloalkane structure is preferable, and a cyclohexane structure is more preferable.

Specific examples of the (meth)acrylic monomer (x) include isobornyl acrylate (Tg: 94° C.), isobornyl methacrylate (Tg: 180° C.), cyclohexyl acrylate (Tg: 16° C.), cyclohexyl methacrylate (Tg: 56° C.), dicyclopentanyl acrylate (Tg: 120° C.), 1,4-cyclohexanedimethanol monoacrylate (Tg: 18° C.), 1-ethylcyclohexyl acrylate (Tg: 26° C.), 1-ethylcyclooctyl acrylate (Tg: 80° C.), 2-methyl-2-adamantyl acrylate (Tg: 115° C.), 2-methyl-2-adamantyl methacrylate (Tg: 180° C.), and adamantyloxymethyl methacrylate (Tg: 100° C.). The glass transition temperature of each (meth)acrylic monomer (x) is shown in parentheses. The (meth)acrylic monomer (x) may be used alone or two or more thereof may be used in combination.

Among these, as the (meth)acrylic monomer (x), cyclohexyl acrylate, cyclohexyl methacrylate, isobornyl acrylate and isobornyl methacrylate are preferable, cyclohexyl acrylate and cyclohexyl methacrylate are more preferable, and cyclohexyl methacrylate is more preferable.

(Meth)Acrylic Monomer (y)

The acrylic polyol (A) preferably contains the (meth)acrylic monomer (y) component having a glass transition temperature of −10° C. or lower.

The glass transition temperature of the (meth)acrylic monomer (y) is preferably −10° C. or lower, more preferably −12° C. or lower, and more preferably −15° C. or lower. The glass transition temperature of the (meth)acrylic monomer (y) is preferably −90° C. or higher. The (meth)acrylic monomer (y) having a glass transition temperature of −10° C. or lower can enhance the elongation properties of the surface protective layer.

Examples of the (meth)acrylic monomer (y) include a hydroxyl group-containing (meth)acrylic monomer (y1) having a glass transition temperature of −10° C. or lower such as 2-hydroxylethylacrylate (Tg: −15° C.), 4-hydroxybutylacrylate (Tg: −32° C.), and an adduct of hydroxyethylmethacrylate and 2 mol of caprolactone (CH₂═C(CH₃)COO(CH₂)₂O[CO(CH₂)₅O]₂H) (Tg: −28° C.), caprolactone acrylate [an adduct of hydroxyethylacrylate and 2 mol of caprolactone (CH₂═CHCOO(CH₂)₂O[CO(CH₂)₅O]₂H] (Tg: −53° C.); an alkyl(meth)acrylate (y2) having a glass transition temperature of −10° C. or lower such as ethyl acrylate (Tg: −22° C.), normal-butyl acrylate (Tg: −54° C.), isobutyl acrylate (Tg: −24° C.), isononyl acrylate (Tg: −90° C.), 2-ethylhexyl acrylate (Tg: −85° C.), lauryl acrylate (Tg: −30° C.), lauryl methacrylate (Tg: −64° C.), isodecylacrylate (Tg: −60° C.) isooctyl acrylate (Tg: −54° C.), tridecyl acrylate (Tg: −55° C.), and tridecyl methacrylate (Tg: −40° C.); 2-(2-ethoxyethoxy)ethyl acrylate (Tg: −54° C.), 2-methoxyethyl acrylate (Tg: −50° C.), ethylcarbitol acrylate (Tg: −67° C.), and methoxytriethylene glycol acrylate (Tg: −55° C.). The glass transition temperature of each (meth)acrylic monomer (y) is shown in parentheses. The (meth)acrylic monomer (y) may be used alone or two or more types thereof may be used in combination.

As the (meth)acrylic monomer (y), a hydroxyl group-containing (meth)acrylic monomer (y1) having a glass transition temperature of −10° C. or lower and an alkyl (meth)acrylate (y2) having a glass transition temperature of −10° C. or lower are preferable. 2-Hydroxyethyl acrylate, 4-hydroxybutyl acrylate, ethyl acrylate, normal-butyl acrylate, isobutyl acrylate, isononyl acrylate, and 2-ethylhexyl acrylate are more preferable. 2-Hydroxyethyl acrylate, normal-butyl acrylate, and 2-ethylhexyl acrylate are more preferable. The alkyl (meth)acrylate (y2) having a glass transition temperature of −10° C. or lower preferably has no hydroxyl group.

In the acrylic polyol (A), the mass ratio of the (meth)acrylic monomer (y) component having a glass transition temperature of −10° C. or lower to the (meth)acrylic monomer (x) component having a glass transition temperature higher than −10° C. and having an alicyclic structure, i.e., [(mass of (meth)acrylic monomer (y) component/(mass of (meth)acrylic monomer (x) component)]], is preferably 1.1 or more, more preferably 1.2 or more, and more preferably 2.0 or more. In the acrylic polyol (A), the mass ratio of the (meth)acrylic monomer (y) component having a glass transition temperature of −10° C. or lower to the (meth)acrylic monomer (x) component having a glass transition temperature higher than −10° C. and having an alicyclic structure, i.e., [(mass of (meth)acrylic monomer (y) component/(mass of (meth)acrylic monomer (x) component)]] is preferably 3.6 or less, more preferably 3.5 or less, and more preferably 3.0 or less. The mass ratio [(mass of (meth)acrylic monomer (y) component/(mass of (meth)acrylic monomer (x) component)] being 1.1 or more can enhance the elongation properties of the surface protective layer. The mass ratio [(mass of (meth)acrylic monomer (y) component/(mass of (meth)acrylic monomer (x) component)] being 3.6 or less can enhance the fouling resistance of the surface protective layer.

The acrylic polyol (A) preferably contains a hydroxyl group-containing (meth)acrylic monomer (z) component having a glass transition temperature higher than −10° C. Note that the “hydroxyl group-containing (meth)acrylic monomer (z) having a glass transition temperature higher than −10° C.” may be simply referred to as a “hydroxyl group-containing (meth)acrylic monomer (z)”. The hydroxyl group-containing (meth)acrylic monomer (z) preferably has no alicyclic structure.

The glass transition temperature of the hydroxyl group-containing (meth)acrylic monomer (z) is preferably higher than −10° C., more preferably −8° C. or higher, and more preferably −7° C. or higher. The glass transition temperature of the hydroxyl group-containing (meth)acrylic monomer (z) is preferably 80° C. or lower. The hydroxyl group-containing (meth)acrylic monomer (z) having a glass transition temperature higher than −10° C. can enhance the acid resistance and fouling resistance of the surface protective layer.

Examples of the hydroxyl group-containing (meth)acrylic monomer (z) include 2-hydroxyethyl methacrylate (Tg: 55° C.), 2-hydroxypropyl methacrylate (Tg: 26° C.), and 2-hydroxypropyl acrylate (Tg: −7° C.). The hydroxyl group-containing (meth)acrylic monomer (z) may be used alone or two or more types thereof may be used in combination. Among these, 2-hydroxyethyl methacrylate is preferable.

Acrylic Polyol (A1)

More preferable examples of the acrylic polyol (A) include an acrylic polyol (A1) containing: a (meth)acrylic monomer (x) component having a glass transition temperature higher than −10° C. and having an alicyclic structure; and a (meth)acrylic monomer (y) component having a glass transition temperature of −10° C. or lower and containing a hydroxyl group-containing (meth)acrylic monomer (y1) component having a glass transition temperature of −10° C. or lower and an alkyl (meth)acrylate (y2) component having a glass transition temperature of −10° C. or lower.

The “acrylic polyol (A1) containing: a (meth)acrylic monomer (x) component having a glass transition temperature higher than −10° C. and having an alicyclic structure; and a (meth)acrylic monomer (y) component having a glass transition temperature of −10° C. or lower and containing a hydroxyl group-containing (meth)acrylic monomer (y1) component having a glass transition temperature of −10° C. or lower and an alkyl (meth)acrylate (y2) component having a glass transition temperature of −10° C. or lower” may be simply referred to as an “acrylic polyol (A1)”.

The acrylic polyol (A1) preferably contains no hydroxyl group-containing (meth)acrylic monomer (z) component having a glass transition temperature higher than −10° C.

In the acrylic polyol (A1), the content of the (meth)acrylic monomer (x) component is preferably 10% by mass or more, more preferably 15% by mass or more, and particularly preferably 20% by mass or more. In the acrylic polyol (A1), the content of the (meth)acrylic monomer (x) component is preferably 50% by mass or less, more preferably 45% by mass or less, and particularly preferably 42% by mass or less. The (meth)acrylic monomer (x) component, when its component is equal to or more than 10% by mass, can enhance the acid resistance of the surface protective layer. The (meth)acrylic monomer (x) component, when its component is equal to or less than 50% by mass, can maintain the excellent elongation properties of the surface protective layer.

In the acrylic polyol (A1), the content of the hydroxyl group-containing (meth)acrylic monomer (y1) component having a glass transition temperature of −10° C. or lower is preferably 7% by mass or more, more preferably 10% by mass or more, and particularly preferably 14% by mass or more. In the acrylic polyol (A1), the content of the hydroxyl group-containing (meth)acrylic monomer (y1) component having a glass transition temperature of −10° C. or lower is preferably 35% by mass or less, more preferably 30% by mass or less, and particularly preferably 27% by mass or less. The hydroxyl group-containing (meth)acrylic monomer (y1) component, when its content is equal to or more than 7% by mass, can enhance the weather resistance and fouling resistance of the surface protective layer. The hydroxyl group-containing (meth)acrylic monomer (y1) component, when its content is equal to or less than 35% by mass, can maintain the excellent elongation properties of the surface protective layer.

In the acrylic polyol (A1), the content of the alkyl(meth)acrylate (y2) component having a glass transition temperature of −10° C. or lower is preferably 30% by mass or more, more preferably 35% by mass or more, and particularly preferably 42% by mass or more. In the acrylic polyol (A1), the content of the alkyl(meth)acrylate (y2) component having a glass transition temperature of −10° C. or lower is preferably 80% by mass or less, more preferably 70% by mass or less, and particularly preferably 66% by mass or less. The alkyl(meth)acrylate (y2) component, when its content is equal to or more than 30 mass %, can enhance the elongation properties of the surface protective layer. The alkyl(meth)acrylate (y2) component, when its content is equal to or less than 80% by mass, can enhance the acid resistance of the surface protective layer.

Acrylic Polyol (A2)

Furthermore, more preferable examples of the acrylic polyol (A) include an acrylic polyol (A2) containing: the (meth)acrylic monomer (x) component having a glass transition temperature higher than −10° C. and having an alicyclic structure; the (meth)acrylic monomer (y) component having a glass transition temperature of −10° C. or lower and containing the alkyl (meth)acrylate (y2) component having a glass transition temperature of −10° C. or lower; and the hydroxyl group-containing (meth)acrylic monomer (z) component having a glass transition temperature higher than −10° C.

The “acrylic polyol (A2) containing: the (meth)acrylic monomer (x) component having a glass transition temperature higher than −10° C. and having an alicyclic structure; the (meth)acrylic monomer (y) component having a glass transition temperature of −10° C. or lower and containing the alkyl (meth)acrylate (y2) component having a glass transition temperature of −10° C. or lower; and the hydroxyl group-containing (meth)acrylic monomer (z) component having a glass transition temperature higher than −10° C.” may be simply referred to as an “acrylic polyol (A2)”.

In the acrylic polyol (A2), the content of the (meth)acrylic monomer (x) component is preferably 10% by mass or more, more preferably 15% by mass or more, and particularly preferably 20% by mass or more. In the acrylic polyol (A2), the content of the (meth)acrylic monomer (x) component is preferably 50% by mass or less, more preferably 45% by mass or less, and particularly preferably 42% by mass or less. The (meth)acrylic monomer (x) component, when its content is equal to or more than 10% by mass, can enhance the acid resistance of the surface protective layer. The (meth)acrylic monomer (x) component, when its content is equal to or less than 50% by mass, can maintain the excellent elongation properties of the surface protective layer.

In the acrylic polyol (A2), the content of the alkyl(meth)acrylate (y2) component having a glass transition temperature of −10° C. or lower is preferably 30% by mass or more, more preferably 35% by mass or more, and particularly preferably 42% by mass or more. In the acrylic polyol (A2), the content of the alkyl(meth)acrylate (y2) component having a glass transition temperature of −10° C. or lower is preferably 80% by mass or less, more preferably 70% by mass or less, and particularly preferably 66% by mass or less. The alkyl(meth)acrylate (y2) component, when its content is equal to or more than 30% by mass, can enhance the elongation properties of the surface protective layer. The alkyl(meth)acrylate (y2) component, when its content is equal to or less than 80% by mass, can enhance the acid resistance of the surface protective layer.

In the acrylic polyol (A2), the content of the hydroxyl group-containing (meth)acrylic monomer (z) component having a glass transition temperature higher than −10° C. is preferably 7% by mass or more, more preferably 10% by mass or more, and particularly preferably 16% by mass or more. In the acrylic polyol (A2), the content of the hydroxyl group-containing (meth)acrylic monomer (z) component having a glass transition temperature higher than −10° C. is preferably 40% by mass or less, more preferably 35% by mass or less, and particularly preferably 30% by mass or less. The hydroxyl group-containing (meth)acrylic monomer (z) component, when its content is equal to or more than 7% by mass, can enhance the weather resistance and fouling resistance of the surface protective layer. The hydroxyl group-containing (meth)acrylic monomer (z) component, when its content is equal to or less than 40% by mass, can maintain the excellent elongation properties of the surface protective layer.

As a polymerization method of the acrylic polyol (A), a conventionally known method is employed. Examples thereof include a method of polymerizing the above-described monomers in the presence of a radical polymerization initiator. Specifically, for example, mentioned is a method in which the above-described monomers, a polymerization initiator, and a polymerization solvent are supplied into a reaction vessel, and are heated at a temperature of 60 to 80° C. for 4 to 48 hours, so that the monomers are radically polymerized.

The weight-average molecular weight of the acrylic polyol (A) is preferably 8,000 or more, and more preferably 10,000 or more. The weight-average molecular weight of the acrylic polyol (A) is preferably 120,000 or less, and more preferably 100,000 or less. The acrylic polyol (A) having a weight-average molecular weight of 8,000 or more can enhance the acid resistance and weather resistance of the surface protective layer. The acrylic polyol (A) having a weight-average molecular weight of 120,000 or less can enhance the elongation properties and fouling resistance of the surface protective layer.

The weight-average molecular weight of the acrylic polyol (A) refers to a value obtained by converting the molecular weight measured by gel permeation chromatography (GPC) into a value in terms of polystyrene. For example, measurement can be performed under the following measurement conditions.

The acrylic polyol (A) is dissolved in tetrahydrofuran to obtain a measurement sample in which the concentration of the acrylic polyol (A) is 2.0 g/L. The measurement sample is used to measure the weight-average molecular weight of the acrylic polyol (A) by gel permeation chromatography (GPC) equipped with a differential refractive index detector (RID). The weight-average molecular weight of the acrylic polyol (A) can be measured by the following measurement apparatus and measurement conditions:
Measurement apparatus: “HLC-8320GPC” manufactured by Tosoh Corporation
Differential refractive index detector: RI detector installed in the measurement apparatus
Column: two columns of “TSKgel SuperHZM-H” manufactured by Tosoh Corporation
Mobile phase: tetrahydrofuran
Column flow rate: 0.35 mL/min
Sample concentration: 2.0 g/L
Injection volume: 10 μL
Measurement temperature: 40° C.
Molecular-weight marker: standard polystyrene (standard material manufactured by POLYMER LABORATORIES LTD.)

(Polystyrene-Medium Molecular Weight Calibration Kit)

The hydroxyl value of the acrylic polyol (A) is preferably 25 mgKOH/g or more, more preferably 30 mgKOH/g or more, and more preferably 36 mgKOH/g or more. The hydroxyl value of the acrylic polyol (A) is preferably 135 mgKOH/g or less, more preferably 130 mgKOH/g or less, and particularly preferably 125 mgKOH/g or less. The acrylic polyol (A), when its hydroxyl value is equal to or more than 25 mgKOH/g, can enhance the weather resistance of the surface protective layer. The acrylic polyol (A), when its hydroxyl value is equal to or less than 135 mgKOH/g, can maintain the excellent elongation properties of the surface protective layer.

The hydroxyl value of the acrylic polyol (A) refers to a value measured in accordance with 4.2 B method in JIS K 1557-1:2007 (ISO 14900:2001) “Plastics—Polyols for use in the production of polyurethane—Part 1: Determination of hydroxyl value”.

The glass transition temperature of the acrylic polyol (A) is preferably −60° C. or higher, and more preferably −50° C. or higher. The glass transition temperature of the acrylic polyol (A) is preferably 0° C. or lower, and preferably −2° C. or lower. The acrylic polyol (A), when its glass transition temperature is equal to or higher than −60° C., can enhance the acid resistance and fouling resistance of the surface protective layer. The acrylic polyol (A), when its glass transition temperature is equal to or lower than 0° C., can enhance the elongation properties of the surface protective layer.

The glass transition temperature of the acrylic polyol (A) can be determined from Fox equation represented by the following equation (1) using the content ratio (weight fraction) and glass transition temperature of each monomer constituting the acrylic polyol (A).

$$\begin{matrix}[ Equation 1 ] & \\ 1 / ( 273 + Tg ) = {\sum }_{i = 1}^{n} [ Wi / ( 273 + Tgi ) ] & ( 1 )\end{matrix}$$

(in the equation (1), Tg is a glass transition temperature (° C.) of the acrylic polyol (A), Wi is a content ratio (weight fraction) of a monomer i, Tgi is a glass transition temperature (° C.) of the monomer and n is an integer indicating the number of monomer types.)

Herein, the “glass transition temperature of the monomer i” refers to the glass transition temperature of a homopolymer in which the monomer i is homopolymerized. The glass transition temperature of the homopolymer of a monomer i is measured by differential scanning calorimetry (DSC) in accordance with JIS K 7121 (1987). The thus measured value is the “glass transition temperature of the monomer i”.

In the two-component curable coating agent of the present invention, the content of the acrylic polyol (A) in the polyol contained in the main agent is preferably 1 part by mass or more, more preferably 5 parts by mass or more, more preferably 8 parts by mass or more, more preferably 20 parts by mass or more, and more preferably 35 parts by mass or more, relative to 100 parts by mass of the total amount of the epoxy polyol (P) and the acrylic polyol (A). The content of the acrylic polyol (A) in the polyol contained in the main agent is preferably 70 parts by mass or less, more preferably 65 parts by mass or less, and more preferably 60 parts by mass or less, relative to 100 parts by mass of the epoxy polyol (P) and the acrylic polyol (A). The acrylic polyol (A), when its content is equal to or more than 1 part by mass, can enhance the acid resistance and weather resistance of the surface protective layer. The acrylic polyol (A), when its content is equal to or less than 70 parts by mass, can enhance the elongation properties and fouling resistance of the surface protective layer.

The main agent of the two-component curable coating agent may include a curing catalyst. Examples of the curing catalyst include an organometallic compound such as dibutyltin oxide, tin 2-ethylcaproate, tin octylate, and dibutyltin dilaurate. The curing catalyst may be used alone, or two or more types thereof may be used in combination.

[Curing Agent]

The two-component curable coating agent of the present invention includes a curing agent containing a polyisocyanate. The polyisocyanate preferably has two or more isocyanate groups (—NCO) within one molecule, but preferably has three or more isocyanate groups (—NCO) within one molecule. The polyisocyanate having three or more isocyanate groups within one molecule can enhance the fouling resistance of the surface protective layer.

Examples of the polyisocyanate include an aliphatic polyisocyanate and a polyisocyanate having an alicyclic structure. The polyisocyanate may be used alone, or two or more types thereof may be used in combination.

Examples of the aliphatic polyisocyanate include an acyclic aliphatic polyisocyanate such as ethylene diisocyanate, tetramethylene diisocyanate, hexamethylene diisocyanate, dodecamethylene diisocyanate, 1,6,11-undecanetriisocyanate, 2,2,4-trimethylhexamethylene diisocyanate, 2,6-diisocyanatomethyl caproate, bis(2-isocyanatoethyl) fumarate, bis(2-isocyanatoethyl) carbonate, and 2-isocyanatoethyl-2,6-diisocyanato hexanoate. Among these, hexamethylene diisocyanate is preferable.

Examples of the polyisocyanate having an alicyclic structure include 4,4′-dicyclohexylmethane diisocyanate (hydrogenated MDI), isophorone diisocyanate, methylcyclohexylene diisocyanate (hydrogenated TDI), and 1,3-bis(isocyanatomethyl)cyclohexane (hydrogenated m-XDI).

Examples of the polyisocyanate also include a modified polyisocyanate. Examples of the modified polyisocyanate include an isocyanurate form, a biuret form, and an adduct of the polyisocyanate. Three molecules of a polyisocyanate can form an isocyanurate or biuret form. Three molecules of a polyisocyanate can be reacted with trimethylolpropane to form a trimeric adduct.

Examples of the modified polyisocyanate include:
biuret and isocyanurate forms of an aliphatic polyisocyanate such as ethylene diisocyanate, tetramethylene diisocyanate, hexamethylene diisocyanate, and dodecamethylene diisocyanate;
biuret and isocyanurate forms of a polyisocyanate having an alicyclic structure such as 4,4′-dicyclohexylmethane diisocyanate (hydrogenated MDI), isophorone diisocyanate, methylcyclohexylene diisocyanate (hydrogenated TDI), and 1,3-bis(isocyanatomethyl)cyclohexane (hydrogenated m-XDI);
a trimeric adduct of trimethylolpropane (TMP) and hydrogenated MDI;
a trimeric adduct of 3 moles of any one of the polyisocyanates such as isophorone diisocyanate, methylcyclohexylene diisocyanate (hydrogenated TDI), and 1,3-bis(isocyanatomethyl)cyclohexane (hydrogenated m-XDI) with 1 mole of trimethylolpropane (TMP);
an adduct of trimethylolpropane (TMP) with two moles of isophorone diisocyanate and one mole of hexamethylene diisocyanate (HDI); and
a bifunctional polyurethane diisocyanate obtained by performing an addition reaction of a diol with an aliphatic diisocyanate such as ethylene diisocyanate, tetramethylene diisocyanate, and hexamethylene diisocyanate.

As the polyisocyanate, a biuret form of a polyisocyanate and an isocyanurate form of a polyisocyanate are preferable. An isocyanurate form of a polyisocyanate is more preferable, and an isocyanurate form of an aliphatic polyisocyanate is particularly preferable. These polyisocyanates allow for the formation of a surface protective layer having excellent weather resistance, acid resistance, fouling resistance, and elongation properties.

In the two-component curable coating agent, the equivalent ratio (isocyanate group/hydroxyl group) of the isocyanate group of the polyisocyanate contained in the curing agent to the hydroxyl group of the polyol contained in the main agent is preferably 0.8 or more, and more preferably 0.9 or more. In the two-component curable coating agent, the equivalent ratio (isocyanate group/hydroxyl group) of the isocyanate group of the polyisocyanate contained in the curing agent to the hydroxyl group of the polyol contained in the main agent is preferably 1.2 or less, and more preferably 1.1 or less. The equivalent ratio (isocyanate group/hydroxyl group) being equal to or more than 0.8 allows for the formation of a surface protective layer having excellent fouling resistance. The equivalent ratio (isocyanate group/hydroxyl group) being equal to or less than 1.2 allows for the formation of a surface protective layer having excellent weather resistance.

In order to determine the equivalent ratio (isocyanate group/hydroxyl group) of the isocyanate group of the polyisocyanate contained in the curing agent to the hydroxyl group of the polyol contained in the main agent, the number of the isocyanate groups of the polyisocyanate is divided by the number of the hydroxyl groups of the entire polyol.

The polyol contained in the main agent contains a plurality of types of polyols including the epoxy polyol (P) and the acrylic polyol (A). Therefore, the number of the hydroxyl groups of the entire polyol is a value determined by the following expression.

Number of hydroxyl groups of entire polyol=(W₁×H₁/56100)+(W₂×H₂/56100)+ . . . +(Wₘ×Hₘ/56100)

(In the expression, Wₘ is the content (g) of the m-th polyol in the entire polyol, Hₘ is the hydroxyl value of the m-th polyol, and m is an integer indicating the number of polyol types.)

The hydroxyl value of the m-th polyol refers to a value measured in accordance with 4.2 B method in JIS K 1557-1:2007 (ISO 14900:2001) “Plastics—Polyols for use in the production of polyurethane—Part 1: Determination of hydroxyl value”.

The number of the isocyanate groups of the polyisocyanate is determined by the following expression. An isocyanate equivalent refers to a value obtained by dividing the molecular weight of a polyisocyanate by the number of isocyanate groups within one molecule of the polyisocyanate. Specifically, the isocyanate equivalent is a value measured in accordance with JIS K 1603.

Number of isocyanate groups of polyisocyanate=(content (g) of polyisocyanate)/(isocyanate equivalent)

Additives may be added to the main agent and the curing agent of the two-component curable coating agent as necessary within a range not impairing the physical properties of the two-component curable coating agent. Examples of the additive include an antioxidant, a light stabilizer, a heat-resistant stabilizer, an antistatic agent, and an antifoaming agent.

The main agent and the curing agent of the two-component curable coating agent may contain a solvent. When the main agent of the two-component curable coating agent contains a solvent, the solid content concentration of the main agent is preferably 10 to 90% by mass, and more preferably 20 to 80% by mass. When the curing agent of the two-component curable coating agent contains a solvent, the solid content concentration of the curing agent is preferably to 90% by mass, and more preferably 20 to 80% by mass.

Examples of the solvent include hydrocarbons such as pentane, hexane, heptane, and cyclohexane; ketones such as acetone, methyl ethyl ketone, methyl isobutyl ketone, and cyclohexanone; and esters such as ethyl acetate and butyl acetate. The solvent may be used alone, or two or more types thereof may be used in combination.

It is preferable that the two-component curable coating agent of the present invention be used to form a surface protective layer for protecting the surface of an article. As the surface protective layer, a cured film of the two-component curable coating agent of the present invention can be used. The surface protective layer is preferably used in a multilayer film that includes the surface protective layer and an adhesive layer. For example, when the multilayer film is bonded to the surface of the article with the adhesive layer, the surface protective layer can be applied to the surface of the article.

The two-component curable coating agent of the present invention allows for the formation of the surface protective layer having the excellent weather resistance, acid resistance, and fouling resistance as described above. The use of such a surface protective layer can maintain a visually favorable appearance of the surface of the article over a long period of time. The surface protective layer that is formed from the two-component curable coating agent of the present invention also has the excellent flexibility and elongation properties. To bond the multilayer film that includes the surface protective layer to the surface of the article, the multilayer film is placed on the surface of the article, and a squeegee (pallet) is then pressed and slid on the surface protective layer. During this action, a tensile force is applied to the multilayer film by the squeegee, but the surface protective layer can withstand such a tensile force. The surface protective layer being able to withstand the tensile force allows for a reduction in cracking and cleavage in the surface protective layer. Therefore, the surface protective layer formed from the two-component curable coating agent of the present invention can be suitably used as the multilayer film. Hereinafter, the multilayer film including the surface protective layer will be described.

### <Multilayer Film>

The multilayer film of the present invention includes: a substrate layer; the surface protective layer, which is the cured film of the two-component curable coating agent as described above, that is layered on and integrated with a first surface of the substrate layer; and an adhesive layer that is layered on and integrated with a second surface of the substrate layer.

[Substrate Layer]

The multilayer film of the present invention includes the substrate layer. The substrate layer preferably contains at least one of a thermoplastic resin and a thermoplastic elastomer. Thus, the elongation properties of the multilayer film can be enhanced.

Examples of the thermoplastic resin include a polyurethane resin, a polyolefin resin, a polyester resin, a polyamide resin, a polyvinyl resin, and a polycarbonate resin. Examples of the thermoplastic elastomer include a thermoplastic polyurethane elastomer, a thermoplastic styrene elastomer, a thermoplastic acrylic elastomer, a thermoplastic polyolefin elastomer, a thermoplastic polyvinyl chloride elastomer, a thermoplastic polyester elastomer, and a thermoplastic polyamide elastomer. Each of the thermoplastic resin and the thermoplastic elastomer may be used alone, or two or more types thereof may be used in combination.

Among these, the substrate layer preferably contains a thermoplastic resin, and more preferably contains a polyurethane resin. Furthermore, the substrate layer preferably contains a thermoplastic elastomer, and more preferably contains a thermoplastic polyurethane elastomer. The thickness of the substrate layer is not particularly limited, and may be 10 to 300 μm, and preferably 20 to 200 μm.

[Surface Protective Layer]

The multilayer film of the present invention includes the surface protective layer layered on and integrated with the first surface of the substrate layer. The surface protective layer is the cured film of the two-component curable coating agent.

Herein, an arbitrary surface of the substrate layer is the “first surface of the substrate layer”, and a surface of the substrate layer on a side opposite to the first surface is a “second surface of the substrate layer”. At least one or both of the first and second surfaces of the substrate layer is preferably a surface having the largest area of the substrate layer.

The thickness of the surface protective layer is preferably 1 μm or more, and more preferably 5 μm or more. The thickness of the surface protective layer is preferably 50 μm or less, and more preferably 30 μm or less. A surface protective layer having a thickness of 1 μm or more can enhance scratch resistance. A surface protective layer having a thickness of 50 μm or less can reduce the occurrence of appearance defect.

As a method for forming the surface protective layer, a method in which the main agent and curing agent in the two-component curable coating agent are mixed and the two-component curable coating agent is applied to the first surface of the substrate layer and heated is used. It is preferable that immediately before applying the two-component curable coating agent to the substrate layer, the main agent and curing agent in the two-component curable coating agent be mixed.

Examples of a method for applying the two-component curable coating agent to the substrate layer include application methods, such as a dip coating method, a spray coating method, a roll coating method, a doctor blade method, and a screen printing method, and casting using a bar coater, an applicator, or the like.

The two-component curable coating agent applied to the substrate layer is heated, resulting in thermal curing. By heating, the polyol contained in the two-component curable coating agent is reacted with the polyisocyanate contained in the two-component curable coating agent to form a polyurethane, and the two-component curable coating agent is cured to form the surface protective layer.

The heating temperature of the two-component curable coating agent is preferably 60 to 180° C., and more preferably 80 to 150° C. The heating time of the two-component curable coating agent is preferably 1 to 30 minutes, and more preferably 1 to 10 minutes.

[Adhesive Layer]

The multilayer film of the present invention includes the adhesive layer that is layered on and integrated with the second surface of the substrate layer. The thickness of the adhesive layer is not particularly limited, and is preferably to 200 μm, and more preferably 20 to 100 μm.

The adhesive layer includes an adhesive. The adhesive is not particularly limited. Examples thereof include an acrylic adhesive, a rubber-based adhesive, a vinyl alkyl ether-based adhesive, a silicone-based adhesive, a polyester-based adhesive, a polyamide-based adhesive, a polyurethane-based adhesive, a fluorine-based adhesive, and an epoxy-based adhesive. Among these, an acrylic adhesive is preferable. The adhesive may be used alone, or two or more types thereof may be used in combination.

Furthermore, the adhesive layer may optionally contain an additive. Examples of the additive include a plasticizer, a filler, an anti-aging agent, an antioxidant, a colorant such as a pigment or a dye such as carbon black, and a tackifier such as a rosin derivative resin, a polyterpene resin, a petroleum resin, and an oil-soluble phenolic resin. The adhesive may be crosslinked by a general-purpose crosslinking agent such as an aziridine-based crosslinking agent, an epoxy-based crosslinking agent, or an isocyanate-based crosslinking agent.

The formation of the adhesive layer is not particularly limited. To form the adhesive layer, an adhesive composition containing the adhesive, and if necessary an additive and a crosslinking agent, is applied to the second surface of the substrate layer followed by drying. Thus, the adhesive layer that is layered on and integrated with the second surface of the substrate layer is formed.

(Metallic Lustrous Layer)

The multilayer film of the present invention may further include a metallic lustrous layer. Because of the metallic lustrous layer, the multilayer film can express lustrous properties, and can decorate the surface of an article such as an automotive in a metallic tone.

The metallic lustrous layer is not particularly limited. The metallic lustrous layer may be disposed on at least one of the first and second surfaces of the substrate layer. If necessary, an anchor coating layer may be additionally placed between the metallic lustrous layer and a layer adjacent to the metallic lustrous layer.

The metallic lustrous layer preferably contains a metal. Examples of the metal include copper, nickel, chromium, titanium, cobalt, molybdenum, zirconium, tungsten, palladium, indium, tin, gold, silver, and aluminum. Among these, indium and aluminum are preferable. These metals may be used alone, or two or more types thereof may be used in combination. The thickness of the metallic lustrous layer is preferably 1 nm to 100 nm, and more preferably 1.5 nm to 7.5 nm.

The anchor coating layer is used to enhance the adhesion between the metallic lustrous layer and the layer adjacent to the metallic lustrous layer. The anchor coating layer preferably includes an anchor coating agent. Examples of the anchor coating agent include a polyester-based resin, a melamine-based resin, a urea-based resin, a urea-melamine-based resin, a urethane resin, an acrylic resin, and a nitrocellulose resin. These anchor coating agents may be used alone, or two or more types thereof may be used in combination. The thickness of the anchor coating layer is not particularly limited, and may be 0.01 to 1 μm.

The multilayer film of the present invention is preferably used to protect the surface of an article, such as a transportation vehicle including an automotive, a train, and an aircraft, a glass, an architecture, and a signage. More specifically, the multilayer film of the present invention is preferably used as a multilayer film for surface protection. For example, a multilayer film that is bonded to and integrated with the surface of the article by intermediary of the adhesive layer can protect the surface of the article against fouling and damage, and such a film can also maintain the appearance of the article over a long period of time.

In particular, the multilayer film of the present invention can be suitably used as an automotive surface protecting multilayer film that protects the surface of an automotive. For example, the multilayer film can be used by bonding to and integrating with a painted surface of an automotive by intermediary of the adhesive layer. Thus, a visually favorable appearance of the surface of the automotive can be maintained over a long period of time.

The surface protective layer formed from the cured film of the two-component curable coating agent of the present invention can be suitably used as the multilayer film. The application of the surface protective layer is not limited to such a form. For example, when the two-component curable coating agent is applied directly to the surface of the article, the surface protective layer can be formed on the surface of the article. Such a surface protective layer is layered on and integrated with the surface of the article without the adhesive layer and the substrate layer. The surface protective layer can also protect the surface of the article. Examples of the article include, but not particularly limited to, a transportation vehicle including an automotive, a train, and an aircraft, a glass, an architecture, and a signage.

As a method for forming the surface protective layer directly on the surface of the article using the two-component curable coating agent, the same method as that for forming the surface protective layer in the multilayer film of the present invention may be performed except that the two-component curable coating agent is directly applied to the surface of the article instead of the first surface of the substrate layer.

### Effect of the Invention

The two-component curable coating agent of the present invention allows for the provision of a surface protective layer having excellent weather resistance, acid resistance, and fouling resistance. Therefore, a visually favorable appearance of the surface of an article to which such a surface protective layer is applied can be maintained over a long period of time.

Furthermore, the two-component curable coating agent of the present invention allows for the provision of a surface protective layer that is flexible and has excellent elongation properties. Therefore, when the surface protective layer is bonded to the surface of the article or when an article having the surface protective layer is molded, even if a tensile force is applied to the surface protective layer, the surface protective layer can withstand the tensile force, allowing for a reduction in the occurrence of cracking and cleavage in the surface protective layer.

### DESCRIPTION OF EMBODIMENTS

Hereinafter, the present invention will be described in more detail with reference to Examples, but the present invention is not limited thereto.

### EXAMPLES

The following raw materials were used in the production of the two-component curable coating agents of Examples and Comparative Examples.

(Epoxy Group-Containing Compound (e))
Epoxy group-containing compound (e1) (a hydrogenated bisphenol A diglycidyl ether which is a reaction product of hydrogenated bisphenol A and epichlorohydrin)
Epoxy group-containing compound (e2) (a neopentyl glycol diglycidyl ether which is a reaction product of neopentyl glycol and epichlorohydrin)
Epoxy group-containing compound (e3) (a bisphenol A diglycidyl ether which is a reaction product of bisphenol A and epichlorohydrin)

### Synthesis of Epoxy Polyol (P)

### Synthesis of Epoxy Polyol (P1)

A reaction vessel was charged with 34.7 parts by mass of the epoxy group-containing compound (e1) (hydrogenated bisphenol A diglycidyl ether) and 45.3 parts by mass of 12-hydroxystearic acid, and 20.0 parts by mass of methyl isobutyl ketone was further supplied thereto and mixed to obtain a raw material composition having a nonvolatile content of 80%. Then, the raw material composition was heated to 110° C., and 0.8 parts by mass of triphenylphosphine was supplied into the reaction vessel while the raw material composition was stirred. Then, the epoxy group-containing compound (e1) and 12-hydroxystearic acid were reacted with each other until the acid value became 1.0 mgKOH/g or lower. This gave an epoxy polyol (P1) in which the carboxyl group of 12-hydroxystearic acid was added to each of the two epoxy groups of the epoxy group-containing compound (e1) (hydrogenated bisphenol A diglycidyl ether) via a ring-opening addition reaction.

### Synthesis of Epoxy Polyol (P2)

A reaction vessel was charged with 26.7 parts by mass of the epoxy group-containing compound (e2) (neopentyl glycol diglycidyl ether) and 53.3 parts by mass of 12-hydroxystearic acid, and 20.0 parts by mass of methyl isobutyl ketone was further supplied thereto and mixed to obtain a raw material composition having a nonvolatile content of 80%. Then, the raw material composition was heated to 110° C., and 0.8 parts by mass of triphenylphosphine was supplied into the reaction vessel while the raw material composition was stirred. Then, the epoxy group-containing compound (e2) and 12-hydroxystearic acid were reacted with each other until the acid value became 1.0 mgKOH/g or lower. This gave an epoxy polyol (P2) in which the carboxyl group of 12-hydroxystearic acid was added to each of the two epoxy groups of the epoxy group-containing compound (e2) (neopentyl glycol diglycidyl ether) via a ring-opening addition reaction.

### Synthesis of Epoxy Polyol (P3)

A reaction vessel was charged with 29.5 parts by mass of the epoxy group-containing compound (e3) (bisphenol A diglycidyl ether) and 50.5 parts by mass of 12-hydroxystearic acid, and 20.0 parts by mass of methyl isobutyl ketone was further supplied thereto and mixed to obtain a raw material composition having a nonvolatile content of 80%. Then, the raw material composition was heated to 110° C., and 0.8 parts by mass of triphenylphosphine was supplied into the reaction vessel while the raw material composition was stirred. Then, the epoxy group-containing compound (e3) and 12-hydroxystearic acid were reacted with each other until the acid value became 1.0 mgKOH/g or lower. This gave an epoxy polyol (P3) in which the carboxyl group of 12-hydroxystearic acid was added to each of the two epoxy groups of the epoxy group-containing compound (e3) (bisphenol A diglycidyl ether) via a ring-opening addition reaction.

### Synthesis of Epoxy Polyol (P4)

A reaction vessel was charged with 44.2 parts by mass of the epoxy group-containing compound (e1) (hydrogenated bisphenol A diglycidyl ether), 7.0 parts by mass of adipic acid, and 28.8 parts by mass of 12-hydroxystearic acid, and 20.0 parts by mass of methyl isobutyl ketone was further supplied thereto and mixed to obtain a raw material composition having a nonvolatile content of 80%. Then, the raw material composition was heated to 110° C., and 0.8 parts by mass of triphenylphosphine was supplied into the reaction vessel while the raw material composition was stirred. Then, the epoxy group-containing compound (e1), adipic acid, and 12-hydroxystearic acid were reacted with one another until the acid value became 1.0 mg KOH/g or lower. This gave an epoxy polyol (P4).

The epoxy polyol (P4) contained 20% by mass or more of the epoxy polyol (Pᵢ) obtained by adding the epoxy group of the epoxy group-containing compound (e1) (hydrogenated bisphenol A diglycidyl ether) to each of the two carboxyl groups of adipic acid via a ring-opening addition reaction to obtain an intermediate product having an epoxy group at each of both molecular terminals, and then adding the carboxyl group of 12-hydroxystearic acid to each of the epoxy groups at both molecular terminals of the molecule of the intermediate product via a ring-opening addition reaction.

This epoxy polyol (Pᵢ) had a structure represented by the general formula (II) [in the general formula (II), R 1 represents a residue of adipic acid with the two carboxyl groups excluded, R 2 represents a residue of the hydrogenated bisphenol A diglycidyl ether with the two epoxy groups excluded, and R 3 represents a residue of 12-hydroxystearic acid with the carboxyl group excluded].

### Synthesis of Acrylic Polyol (A)

### Synthesis Examples 1 to 9

A reaction vessel was charged with 233 parts by mass of methyl isobutyl ketone as a solvent, and the temperature was raised to 70° C. Next, a monomer mixture liquid was prepared by stirring and mixing azobis-2-methylbutyronitrile as a polymerization initiator in a blending amount shown in Table 1 with a monomer composition containing cyclohexyl methacrylate, 2-hydroxyethyl acrylate, 2-hydroxyethyl methacrylate, n-butyl acrylate, and 2-ethylhexyl acrylate in respective blending amounts shown in Table 1. The resulting monomer mixture liquid was added dropwise to the above-described solvent for 3 hours and polymerized for an additional 3 hours. As a result, an acrylic polyol (A) solution (solid content: 30% by mass) containing an acrylic polyol (A) was obtained.

The weight-average molecular weight (Mw), hydroxyl value (mgKOH/g), and glass transition temperature (° C.) of each of the acrylic polyols (A) obtained in Synthesis Examples 1 to 9 are shown in Table 1. The mass ratio (mass of (meth)acrylic monomer (y) component/mass of (meth)acrylic monomer (x) component) of the (meth)acrylic monomer (y) component having a glass transition temperature of −10° C. or lower to the (meth)acrylic monomer (x) component having a glass transition temperature higher than −10° C. and having an alicyclic structure in each of the acrylic polyols (A) obtained in Synthesis Examples 1 to 9 is shown in Table 1.

[Polyisocyanate]
Polyisocyanate (1) (a bifunctional polyurethane diisocyanate obtained by performing an addition reaction of 1 mol of a diol with 2 mol of hexamethylene diisocyanate, number of isocyanate groups within one molecule: 2)
Polyisocyanate (2) (a biuret form of hexamethylene diisocyanate, number of isocyanate groups within one molecule: 3)
Polyisocyanate (3) (an isocyanurate form of hexamethylene diisocyanate, number of isocyanate groups within one molecule: 3)

(Examples 1 to 18 and Comparative Examples 1 to 2) The epoxy polyol (P1) to (P4) and the acrylic polyol (A) obtained in each of Synthesis Examples 1 to 9 were supplied to a reaction vessel in respective blending amounts shown in Table 2, and then methyl isobutyl ketone was further supplied thereto. They were mixed to obtain a main agent (solid content: 30% by mass).

For the acrylic polyol (A) obtained in each of Synthesis Examples 1 to 9, the acrylic polyol (A) solution containing the acrylic polyol (A) was supplied to the reaction vessel so that the amount of each acrylic polyol (A) was the blending amount (solid content) shown in Table 2.

Next, the polyisocyanate (1) to (3) was supplied to another reaction vessel in the blending amount shown in Table 2, and then methyl isobutyl ketone was further supplied thereto. They were mixed to obtain a curing agent (solid content: 30% by mass). As a result, two-component curable coating agents each containing the main agent and the curing agent were obtained.

In the two-component curable coating agent, an equivalent ratio (isocyanate group/hydroxyl group) of the isocyanate group of the polyisocyanate contained in the curing agent to the hydroxyl group of the polyol contained in the main agent is shown in the column of “equivalent ratio (isocyanate group/hydroxyl group)” in Table 2.

Next, the curing agent was added to the main agent and mixed. Immediately after that, the two-component curable coating agent was applied to the first surface of a substrate layer (thermoplastic polyurethane elastomer sheet with a thickness of 150 μm) using a bar coater (No. 16). The applied two-component curable coating agent was heated at 120° C. for 10 minutes, so that the solvent was removed and the agent was thermally cured, thereby forming a surface protective layer (thickness: 10 μm) laminated on and integrated with the first surface of the substrate layer.

Subsequently, 100 parts by mass of an acrylic adhesive (trade name “Hariacron 560CH” manufactured by Harima Chemical Groups Inc.) and 0.5 parts by mass of an isocyanate-based crosslinking agent were mixed to obtain an adhesive composition. Immediately after that, the adhesive composition was applied to the second surface of the substrate layer using a bar coater (No. 24) to obtain a coating film. The coating film was heated at 100° C. for 3 minutes to remove the solvent. After the heating, a roller (weight: 10 kg) with a release paper wound therearound was slowly rolled on the coating film, so that the release paper was layered on the coating film. After that, the coating film was cured at 40° C. for 3 days, so that an adhesive layer (thickness: 25 μm) was formed on the second surface of the substrate layer. Thus, a multilayer film including the substrate layer, the surface protective layer that was layered on and integrated with the first surface of the substrate layer, and the adhesive layer that was layered on and integrated with the second surface of the substrate layer was obtained.

[Evaluation]

The acid resistance, weather resistance, elongation properties, and fouling resistance of the surface protective layers in the multilayer films obtained in Examples and Comparative Examples were each evaluated in accordance with the following procedures.

[Acid Resistance]

Each of the multilayer films was cut to obtain a plane rectangular specimen having a width of 20 mm and a length of 70 mm. The release paper was peeled from the specimen to expose the adhesive layer. The specimen was bonded to a center of a rectangular glass plate (25 mm in width, 75 mm in length) by intermediary of the adhesive layer to obtain a layered body. The entirety of the layered body was then immersed in an aqueous sulfuric acid solution containing 60% by mass of sulfuric acid at a temperature of 50° C. over 1 hour. From the aqueous sulfuric acid solution, the layered body was taken. The HAZE (H₁) (%) of the layered body before immersion in the aqueous sulfuric acid solution and the HAZE (H₂) (%) of the layered body after immersion in the aqueous sulfuric acid solution were each measured with a HAZE meter (trade name “HAZE METER NDH 5000” manufactured by Nippon Denshoku Industries Co., Ltd.) in accordance with JIS K 7136 (2000), and the amount of change in HAZE (%) was calculated by the following expression. The calculated amount of change in HAZE was evaluated in accordance with the following criteria. The results are shown in “acid resistant” of Table 2.

Amount of change in HAZE (%)=H₂−H₁

(Criteria for Evaluating Amount of Change in HAZE)
A: The amount of change in HAZE was 0% or more and less than 2%.
B: The amount of change in HAZE was 2% or more and less than 5%.
C: The amount of change in HAZE was 5% or more and less than 10%.
D: The amount of change in HAZE was 10% or more and less than 20%.
E: The amount of change in HAZE was more than 20%.

[Weather Resistance]

The appearance of the surface protective layer in each of the multilayer films before an accelerated weathering test was visually observed in accordance with 4.4 “appearance of coating film” in JIS K 5600-1.1. All the surface protective layers in the multilayer films obtained in Examples and Comparative Examples had no uneven portion on the respective surfaces and were colorless and transparent.

Subsequently, an accelerated weathering test was performed with an accelerated weathering tester (trade name “EYE SUPER UV TESTER: SUV-W161” manufactured by IWASAKI ELECTRIC CO., LTD.) for 500 hours. In the accelerated weathering test, a step of irradiating the surface of the surface protective layer in each of the multilayer films with ultraviolet rays at an illuminance of 100 mW/cm 2 for 6 hours in an atmosphere with a temperature of 63° C. and a relative humidity of 70% and leaving the multilayer films in an atmosphere with a temperature of 50° C. and a relative humidity of 90% for 2 hours without irradiated with ultraviolet rays was repeated. The appearance of the surface protective layer in each of the multilayer films after the accelerated weathering test was visually observed in accordance with 4.4 “appearance of coating film” in JIS K5600-1.1 and evaluated in accordance with the following criteria. The results are shown in “weather resistant” of Table 2.

(Criteria for Evaluation of Appearance of Surface Protective Layer after Accelerated Weathering Test)
A: No uneven portion was formed on the surface of the surface protective layer, and the surface protective layer was not discolored into yellow or white.
B: An uneven portion was formed on a slightly small portion of the surface of the surface protective layer, but the surface protective layer was not discolored into yellow or white.
C: An uneven portion was formed on a small portion of the surface of the surface protective layer, and a small portion of the surface protective layer was discolored into yellow or white.
D: An uneven portion was formed on the entirety of the surface of the surface protective layer, and the surface protective layer was entirely discolored into yellow and white.

[Elongation Properties]

Each of the multilayer films was cut into a shape of “specimen type 5” specified by JIS K 7127, and the release paper was peeled and removed to obtain a specimen (25 mm in width, 115 mm in length). The elongation ratio of the specimen was measured with a tensile tester (product name “Precision universal tensile tester Autograph AGS-X” manufactured by Shimadzu Corporation) in accordance with “Plastics-Determination of tensile properties” of JIS K 7127. Specifically, the specimen was stretched under conditions including a tensile speed of 100 mm/min, a distance between chucks of 80 mm, a gauge length of 50 mm, and a temperature of 23° C. At a time point when the surface protective layer was cracked, the gauge length L (mm) of the specimen was measured, and the elongation ratio was calculated by the following expression. The calculated elongation ratio was evaluated in accordance with the following criteria. The results are shown in “elongation properties” of Table 2.

Elongation ratio (%)=100×(L−50)/50

(Evaluation Criteria for Elongation Ratio)
A: The elongation ratio was 85% or more.
B: The elongation ratio was 80% or more and less than 85%.
C: The elongation ratio was 75% or more and less than 80%.
D: The elongation ratio was less than 75%.

[Fouling Resistance]

On the surface of the surface protective layer in each of the multilayer films, a line was drawn with a commercially available oil-based marker (trade name “Mckee” available from ZEBRA Co., Ltd.”) and then left for 1 minute. Subsequently, 0.1 g of n-hexadecane was dropped on the line drawn on the surface of the surface protective layer. The n-hexadecane attached to the surface of the surface protective layer was wiped off ten times with a cellulose non-woven fabrics (trade name “BEMCOT M-3” available from Asahi Kasei Corporation) under application of a load of 300 g. The appearance of the surface protective layer was then visually observed in accordance with 4.4 “appearance of coating film” in JIS K 5600-1.1 and evaluated in accordance with the following criteria. The results are shown in “fouling resistance” of Table 2.

(Criteria for Evaluation of Appearance of Surface Protective Layer after Wiping)
A: The line drawn on the surface of the surface protective layer was completely wiped off. The line was no longer visible.
B: The line drawn on the surface of the surface protective layer was significantly faintly seen.
C: The line drawn on the surface of the surface protective layer was faintly seen.
D: The line drawn on the surface of the surface protective layer was clearly seen.

| | | | Synthesis Example | | | | |
|---|---|---|---|---|---|---|---|
| | | | 1 | 2 | 3 | 4 | 5 |
| Blending | (Meth)acrylic | Cyclohexyl methacrylate | 20 | 22 | 25 | 25 | 25 |
| amount | monomer (x) | [Tg: 56° C.] | | | | | |
| (part by | Hydroxyl group- | 2-hydroxyethyl | 14 | 14 | 0 | 0 | 0 |
| mass) | containing | acrylate | | | | | |
| | (meth)acrylic | [Tg: −15° C.] | | | | | |
| | monomer (y1) | | | | | | |
| | Hydroxyl group- | 2-hydroxyethyl | 0 | 0 | 16 | 16 | 16 |
| | containing | methacrylate | | | | | |
| | (meth)acrylic | [Tg: 55° C.] | | | | | |
| | monomer (z) | | | | | | |
| | Alkyl | n-Butyl acrylate | 0 | 33 | 36 | 36 | 36 |
| | (meth)acrylate | [Tg: −54° C.] | | | | | |
| | (y2) | 2-ethylhexyl acrylate | 66 | 31 | 23 | 23 | 23 |
| | | [Tg: −85° C.] | | | | | |
| | Polymerization | Azobis-2- | 4.0 | 4.0 | 6.0 | 3.0 | 4.0 |
| | initiator | methylbutyronitrile | | | | | |
| | Solvent | Methyl isobutyl ketone | 233 | 233 | 233 | 233 | 233 |

| | | | | | | |
|---|---|---|---|---|---|---|
| Acrylic | Weight-average molecular weight (Mw) | 40,000 | 40,000 | 9,000 | 20,000 | 40,000 |
| polyol (A) | Hydroxyl value [mgKOH/g] | 70 | 70 | 70 | 70 | 70 |
| | Glass transition temperature (° C.) | −58 | −44 | −30 | −30 | −30 |
| | Mass ratio (mass of (meth)acrylic monomer (y) | 4.0 | 3.5 | 2.4 | 2.4 | 2.4 |
| | component/mass of (meth)acrylic monomer (x) component) | | | | | |

| | | | Synthesis Example | | | |
|---|---|---|---|---|---|---|
| | | | 6 | 7 | 8 | 9 |
| Blending | (Meth)acrylic | Cyclohexyl methacrylate | 25 | 25 | 38 | 42 |
| amount | monomer (x) | [Tg: 56° C.] | | | | |
| (part by | Hydroxyl group- | 2-hydroxyethyl | 0 | 0 | 0 | 0 |
| mass) | containing | acrylate | | | | |
| | (meth)acrylic | [Tg: −15° C.] | | | | |
| | monomer (y1) | | | | | |
| | Hydroxyl group- | 2-hydroxyethyl | 16 | 16 | 16 | 16 |
| | containing | methacrylate | | | | |
| | (meth)acrylic | [Tg: 55° C.] | | | | |
| | monomer (z) | | | | | |
| | Alkyl | n-Butyl acrylate | 36 | 36 | 46 | 42 |
| | (meth)acrylate | [Tg: −54° C.] | | | | |
| | (y2) | 2-ethylhexyl acrylate | 23 | 23 | 0 | 0 |
| | | [Tg: −85° C.] | | | | |
| | Polymerization | Azobis-2- | 1.0 | 0.8 | 4.0 | 4.0 |
| | initiator | methylbutyronitrile | | | | |
| | Solvent | Methyl isobutyl ketone | 233 | 233 | 233 | 233 |

| | | | | | |
|---|---|---|---|---|---|
| Acrylic | Weight-average molecular weight (Mw) | 100,000 | 110,000 | 40,000 | 40,000 |
| polyol (A) | Hydroxyl value [mgKOH/g] | 70 | 70 | 70 | 70 |
| | Glass transition temperature (° C.) | −30 | −30 | −5 | −1 |
| | Mass ratio (mass of (meth)acrylic monomer (y) | 2.4 | 2.4 | 1.2 | 1.0 |
| | component/mass of (meth)acrylic monomer (x) component) | | | | |

| | | | Example | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Blending | Epoxy polyol (P) | Epoxy polyol (P1) | 53 | 53 | 53 | 53 | 53 | 0 | 0 | 0 | 53 | 53 | 53 |
| amount | | (hydrogenated bisphenol A | | | | | | | | | | | |
| of main | | diglycidyl ether + | | | | | | | | | | | |
| agent | | 12-hydroxystearic acid) | | | | | | | | | | | |
| (part by | | Epoxy poiyol (P2) | 0 | 0 | 0 | 0 | 0 | 53 | 0 | 0 | 0 | 0 | 0 |
| mass) | | (neopentylglycol | | | | | | | | | | | |
| | | diglycidyl ether + | | | | | | | | | | | |
| | | 12-hydroxystearic acid) | | | | | | | | | | | |
| | | Epoxy polyol (P3) | 0 | 0 | 0 | 0 | 0 | 0 | 53 | 0 | 0 | 0 | 0 |
| | | (bisphenol A diglycidyl | | | | | | | | | | | |
| | | ether + 12-hydroxystearic acid) | | | | | | | | | | | |
| | | Epoxy polyol (P4) | 0 | 0 | 0 | 0 | 0 | 0 | 0 | 53 | 0 | 0 | 0 |
| | | (hydrogenated bisphenol | | | | | | | | | | | |
| | | A diglycidyl ether + | | | | | | | | | | | |
| | | adipic acid + | | | | | | | | | | | |
| | | 12-hydroxystearic acid) | | | | | | | | | | | |
| | Acrylic polyol (A) | Synthesis Example 1 | 0 | 0 | 0 | 0 | 0 | 0 | 0 | 0 | 0 | 0 | 47 |
| | | (Tg : −58° C., | | | | | | | | | | | |
| | | Mass ratio [(y)/(x)]: 4.0, Mw: 40000) | | | | | | | | | | | |
| | | Synthesis Example 2 | 47 | 0 | 0 | 0 | 0 | 0 | 0 | 0 | 0 | 0 | 0 |
| | | (Tg : −44° C., | | | | | | | | | | | |
| | | Mass ratio [(y)/(x)]: 3.5, Mw: 40000) | | | | | | | | | | | |
| | | Synthesis Example 3 | 0 | 0 | 0 | 0 | 0 | 0 | 0 | 0 | 0 | 0 | 0 |
| | | (Tg : −30° C., | | | | | | | | | | | |
| | | Mass ratio [(y)/(x)]: 2.4, Mw: 9000) | | | | | | | | | | | |
| | | Synthesis Example 4 | 0 | 47 | 0 | 0 | 0 | 0 | 0 | 0 | 0 | 0 | 0 |
| | | (Tg : −30° C., | | | | | | | | | | | |
| | | Mass ratio [(y)/(x)]: 2.4, Mw: 20000) | | | | | | | | | | | |
| | | Synthesis Example 5 | 0 | 0 | 47 | 0 | 0 | 47 | 47 | 47 | 47 | 47 | 0 |
| | | (Tg : −30° C., | | | | | | | | | | | |
| | | Mass ratio [(y)/(x)]: 2.4, Mw: 40000) | | | | | | | | | | | |
| | | Synthesis Example 6 | 0 | 0 | 0 | 47 | 0 | 0 | 0 | 0 | 0 | 0 | 0 |
| | | (Tg : −30° C., | | | | | | | | | | | |
| | | Mass ratio [(y)/(x)]: 2.4, Mw: 100000) | | | | | | | | | | | |
| | | Synthesis Example 7 | 0 | 0 | 0 | 0 | 0 | 0 | 0 | 0 | 0 | 0 | 0 |
| | | (Tg : −30° C., | | | | | | | | | | | |
| | | Mass ratio [(y)/(x)]: 2.4, Mw: 110000) | | | | | | | | | | | |
| | | Synthesis Example 8 | 0 | 0 | 0 | 0 | 47 | 0 | 0 | 0 | 0 | 0 | 0 |
| | | (Tg : −5° C., | | | | | | | | | | | |
| | | Mass ratio [(y)/(x)]: 1.2, Mw: 40000) | | | | | | | | | | | |
| | | Synthesis Example 9 | 0 | 0 | 0 | 0 | 0 | 0 | 0 | 0 | 0 | 0 | 0 |
| | | (Tg : −1° C., | | | | | | | | | | | |
| | | Mass ratio [(y)/(x)]: 1.0, Mw: 40000) | | | | | | | | | | | |
| Blending | Polyisocyanate | Polyisocyanate (1) | 0 | 0 | 0 | 0 | 0 | 0 | 0 | 0 | 74 | 0 | 0 |
| amount | | (bifunctional polyurethane | | | | | | | | | | | |
| of curing | | diisocyanate, number of NCO | | | | | | | | | | | |
| agent | | groups: 2) | | | | | | | | | | | |
| (part by | | Polyisocyanate (2) | 0 | 0 | 0 | 0 | 0 | 0 | 0 | 0 | 0 | 50 | 0 |
| mass) | | (biuret form, number of | | | | | | | | | | | |
| | | NCO groups: 3) | | | | | | | | | | | |
| | | Polyisocyanate (3) | 54 | 54 | 54 | 54 | 54 | 56 | 54 | 56 | 0 | 0 | 54 |
| | | (isocyanurate form, number | | | | | | | | | | | |
| | | of NCO groups: 3) | | | | | | | | | | | |

| Equivalent ratio (isocyanate group/hydroxyl group) | | 1 | 1 | 1 | 1 | 1 | 1 | 1 | 1 | 1 | 1 | 1 |
|---|---|---|---|---|---|---|---|---|---|---|---|---|
| Evaluation | Acid resistance | A | A | A | A | A | B | A | A | B | B | B |
| | Weather resistance | A | A | A | A | A | A | C | A | A | A | A |
| | Elongation properties | A | A | A | A | A | A | A | B | A | A | A |
| | Fouling resistance | A | A | A | A | A | B | A | A | B | A | C |

| | | | | | | | | | | Comparative | |
|---|---|---|---|---|---|---|---|---|---|---|---|
| | | | Example | | | | | | | Example | |
| | | | 12 | 13 | 14 | 15 | 16 | 17 | 18 | 1 | 2 |
| Blending | Epoxy polyol (P) | Epoxy polyol (Pt) | 53 | 53 | 53 | 42 | 91 | 35 | 95 | 0 | 100 |
| amount | | (hydrogenated bisphenol A | | | | | | | | | |
| of main | | diglycidyl ether + | | | | | | | | | |
| agent | | 12-hydroxystearic acid) | | | | | | | | | |
| (part by | | Epoxy poiyol (P2) | 0 | 0 | 0 | 0 | 0 | 0 | 0 | 0 | 0 |
| mass) | | (neopentylglycol | | | | | | | | | |
| | | diglycidyl ether + | | | | | | | | | |
| | | 12-hydroxystearic acid) | | | | | | | | | |
| | | Epoxy polyol (P3) | 0 | 0 | 0 | 0 | 0 | 0 | 0 | 0 | 0 |
| | | (bisphenol A diglycidyl | | | | | | | | | |
| | | ether + 12-hydroxystearic acid) | | | | | | | | | |
| | | Epoxy polyol (P4) | 0 | 0 | 0 | 0 | 0 | 0 | 0 | 0 | 0 |
| | | (hydrogenated bisphenol | | | | | | | | | |
| | | A diglycidyl ether + | | | | | | | | | |
| | | adipic acid + | | | | | | | | | |
| | | 12-hydroxystearic acid) | | | | | | | | | |
| | Acrylic polyol (A) | Synthesis Example 1 | 0 | 0 | 0 | 0 | 0 | 0 | 0 | 0 | 0 |
| | | (Tg : −58° C., | | | | | | | | | |
| | | Mass ratio [(y)/(x)]: 4,0, Mw: 40000) | | | | | | | | | |
| | | Synthesis Example 2 | 0 | 0 | 0 | 0 | 0 | 0 | 0 | 0 | 0 |
| | | (Tg : −44° C., | | | | | | | | | |
| | | Mass ratio [(y)/(x)]: 3.5, Mw: 40000) | | | | | | | | | |
| | | Synthesis Example 3 | 0 | 47 | 0 | 0 | 0 | 0 | 0 | 0 | 0 |
| | | (Tg : −30° C., | | | | | | | | | |
| | | Mass ratio [(y)/(x)]: 2.4, Mw: 9000) | | | | | | | | | |
| | | Synthesis Example 4 | 0 | 0 | 0 | 0 | 0 | 0 | 0 | 0 | 0 |
| | | (Tg : −30° C., | | | | | | | | | |
| | | Mass ratio [(y)/(x)]: 2.4, Mw: 20000) | | | | | | | | | |
| | | Synthesis Example 5 | 0 | 0 | 0 | 58 | 9 | 65 | 5 | 100 | 0 |
| | | (Tg : −30° C., | | | | | | | | | |
| | | Mass ratio [(y)/(x)]: 2.4, Mw: 40000) | | | | | | | | | |
| | | Synthesis Example 6 | 0 | 0 | 0 | 0 | 0 | 0 | 0 | 0 | 0 |
| | | (Tg : −30° C., | | | | | | | | | |
| | | Mass ratio [(y)/(x)]: 2.4, Mw: 100000) | | | | | | | | | |
| | | Synthesis Example 7 | 0 | 0 | 47 | 0 | 0 | 0 | 0 | 0 | 0 |
| | | (Tg : −30° C., | | | | | | | | | |
| | | Mass ratio [(y)/(x)]: 2.4, Mw: 110000) | | | | | | | | | |
| | | Synthesis Example 8 | 0 | 0 | 0 | 0 | 0 | 0 | 0 | 0 | 0 |
| | | (Tg : −5° C., | | | | | | | | | |
| | | Mass ratio [(y)/(x)]: 1.2, Mw: 40000) | | | | | | | | | |
| | | Synthesis Example 9 | 47 | 0 | 0 | 0 | 0 | 0 | 0 | 0 | 0 |
| | | (Tg : −1° C., | | | | | | | | | |
| | | Mass ratio [(y)/(x)]: 1.0, Mw: 40000) | | | | | | | | | |
| Blending | Polyisocyanate | Polyisocyanate (1) | 0 | 0 | 0 | 0 | 0 | 0 | 0 | 0 | 0 |
| amount | | (bifunctional polyurethane | | | | | | | | | |
| of curing | | diisocyanate, number of NCO | | | | | | | | | |
| agent | | groups: 2) | | | | | | | | | |
| (part by | | Polyisocyanate (2) | 0 | 0 | 0 | 0 | 0 | 0 | 0 | 0 | 0 |
| mass) | | (biuret form, number of | | | | | | | | | |
| | | NCO groups: 3) | | | | | | | | | |
| | | Polyisocyanate (3) | 54 | 54 | 54 | 48 | 76 | 44 | 78 | 24 | 81 |
| | | (isocyanurate form, number | | | | | | | | | |
| | | of NCO groups: 3) | | | | | | | | | |

| Equivalent ratio (isocyanate group/hydroxyl group) | | 1 | 1 | 1 | 1 | 1 | 1 | 1 | 1 | 1 |
|---|---|---|---|---|---|---|---|---|---|---|
| Evaluation | Acid resistance | A | C | A | A | A | A | B | A | B |

| | | | | | | | | | |
|---|---|---|---|---|---|---|---|---|---|
| Weather resistance | A | B | A | A | A | A | C | A | D |
| Elongation properties | C | A | C | B | A | C | A | D | A |
| Fouling resistance | A | A | A | A | A | B | A | C | A |

### INDUSTRIAL APPLICABILITY

According to the present invention, it is possible to provide a two-component curable coating agent capable of forming a surface protective layer having excellent weather resistance, acid resistance, fouling resistance, and elongation properties. According to the surface protective layer formed from the cured film of the two-component curable coating agent, the surface of an article can be protected from fouling and damage, and an excellent appearance can be maintained.

### CROSS-REFERENCE TO RELATED APPLICATION

This application claims priority from Japanese Patent Application No. 2021-35996, filed on Mar. 8, 2021, the disclosure of which is incorporated herein by reference in its entirety.

1. A two-component curable coating agent comprising a main agent that contains a polyol containing an epoxy polyol (P) and an acrylic polyol (A), and a curing agent that contains a polyisocyanate, the epoxy polyol (P) being a reaction product of an epoxy group-containing compound (e) and a carboxyl group-containing compound (c).

2. The two-component curable coating agent according to claim 1, wherein the epoxy group-containing compound (e) has an alicyclic structure.

3. The two-component curable coating agent according to claim 1, wherein the carboxyl group-containing compound (c) contains a carboxyl group-containing compound (c1) having one carboxyl group within one molecule.

4. The two-component curable coating agent according to claim 1, wherein a content of the epoxy polyol (P) in the polyol is 40 parts by mass or more and 92 parts by mass or less, relative to 100 parts by mass of a total amount of the epoxy polyol (P) and the acrylic polyol (A).

5. The two-component curable coating agent according to claim 1, wherein:
the acrylic polyol (A) contains a (meth)acrylic monomer (x) component having a glass transition temperature higher than −10° C. and having an alicyclic structure, and a (meth)acrylic monomer (y) component having a glass transition temperature of −10° C. or lower; and
a mass ratio of the (meth)acrylic monomer (y) component having a glass transition temperature of −10° C. or lower to the (meth)acrylic monomer (x) component having a glass transition temperature higher than −10° C. and having an alicyclic structure is 1.1 or more and 3.6 or less.

6. The two-component curable coating agent according to claim 1, wherein a glass transition temperature of the acrylic polyol (A) is −50° C. or higher and −2° C. or lower, and a weight-average molecular weight of the acrylic polyol (A) is 10,000 or more and 100,000 or less.

7. The two-component curable coating agent according to claim 1, wherein the polyisocyanate has three or more isocyanate groups within one molecule.

8. The two-component curable coating agent according to claim 1, wherein the polyisocyanate includes an isocyanurate form of a polyisocyanate.

9. A multilayer film comprising a substrate layer; a surface protective layer that is layered on and integrated with a first surface of the substrate layer and that is a cured film of the two-component curable coating agent according to claim 1; and an adhesive layer that is layered on and integrated with a second surface of the substrate layer.
